(19) United States
(12) Patent Application Publication
(10) Pub. No.: US 2026/0241461 A1
(43) Pub. Date: Aug. 20, 2026

(54) CUTTING INSERT FOR CUTTING TOOL AS WELL AS CUTTING TOOL AND METHOD FOR PRODUCING CUTTING INSERTS

(71) Applicant: KENNAMETAL INC., Latrobe, PA (US)

(72) Inventors: Fabian Birkmann, Fuerth (DE); Igor Kaufmann, Fuerth (DE)

(21) Appl. No.: 19/538,312

(22) Filed: Feb. 12, 2026

(30) Foreign Application Priority Data
Feb. 14, 2025 (DE) 1020251056765

(51) Int. Cl. B23B 27/14; B23B 27/00

(52) U.S. Cl. CPC B23B 27/145; B23B 27/005; B23B 2200/04; B23B 2200/245; B23B 2200/28; B23B 2200/328; B23B 2200/36

(57) ABSTRACT

A prismatic cutting insert is shown with the cutting surface, also known as the chip face, extending away from the cutting edge and obliquely towards the underside. The chip face comprises a plurality of plate-like surface structures arranged adjacent one another in a row longitudinally to and spaced apart from the cutting edge to form a scale-like overall structure. The individual surface structures run diagonally downward from the cutting edge on one side towards the underside and downward towards a first corner of the cutting insert, such that the surface structures are bound by a lower edge transverse to the cutting edge and an upper edge transverse to the cutting edge and a chip-guiding ledge results between the lower edge of a second surface structure and the adjacent upper edge of the adjacent first surface structure. Furthermore, a cutting tool and method for producing a cutting insert are shown.

### RELATED APPLICATION DATA

The present application claims priority pursuant to 35 U.S.C. § 119(a) to German Patent Application No. 1020251056765, filed Feb. 14, 2025, which is incorporated herein by reference in its entirety.

### FIELD

The invention relates to a prismatic cutting insert for a cutting tool having an underside, an oppositely directed top side comprising a chip face, a free surface adjacent to the chip face, and a cutting edge defined at the transition between the chip face and the free surface. Furthermore, the invention relates to a cutting tool having such a cutting insert, as well as to a method for producing such a cutting insert.

### BACKGROUND

Cutting inserts for cutting tools are known. In particular, cutting inserts are used in order to replace only the cutting insert and not the entire cutting tool due to wear. Even with cutting inserts, there is a lot of wear due to the friction created during the cutting operation. Thus, for example, the cutting inserts become eroded, the coating of the cutting inserts peels off as well as indentations develop within the chip face and the cutting edge becomes worn.

### SUMMARY

It is therefore an object of the invention to reduce the wear caused by friction during the cutting operation while keeping the cost of the cutting insert to a minimum.

According to the present invention, this object is achieved by a prismatic cutting insert of the above-mentioned type, wherein the chip face extends away from the cutting edge and towards the underside at an angle. The chip face has a plurality of plate-like surface structures arranged adjacent to each other in a row longitudinally to and spaced apart from the cutting edge to form a scale-like overall structure. The individual surface structures run diagonally downward from the cutting edge towards the underside on the one hand and downward towards a first corner of the cutting insert on the other hand, such that the surface structures are bound by a lower edge that is transverse to the cutting edge and an upper edge that is transverse to the cutting edge, and a chip-guiding ledge results between the lower edge of a second surface structure and the adjacent upper edge of the adjacent first surface structure.

The invention is based on the basic idea that providing the surface structures reduces the contact surface area between the cutting insert and the object to be cut and its chips, so that wear resulting from the cutting operation can be reduced due to less friction. In particular, by providing the surface structures, ventilation is created so that the material of the cutting insert heats more slowly and thus wear is reduced. In addition, the scale-like overall structure ensures that the chip flow is conveyed away from a corner of the cutting insert, which serves as the cutting edge. The cutting edge is in particular also defined by the radius of the corner.

Preferably, the ledge forms an acute angle with the adjacent cutting edge in plan view. The angle of the ledge ensures accurate or targeted chip guidance at an angle from the cutting edge and away from the workpiece to be machined. This may improve the surface quality of the workpiece to be machined and in particular prevent potential damage to the workpiece.

In one aspect, the ledges running along a cutting edge all run in the same direction and/or parallel to each other. This ensures continuous chip guide in the same direction. In addition, the cutting insert can thus be used for various processing steps, as chip guidance is ensured even with chips of different sizes.

Preferably, the surface structures are macrostructures having a surface measuring from 0.02 to 2 mm² in plan view.

Alternatively, it is also conceivable that the surface structures are microstructures having a maximum surface area of 0.01 mm².

In one aspect, each ledge has a length that is in the range of 0.06 to 0.2 mm.

The ledges may have an end face which may have an inclination greater than 90° and a maximum of 120° towards the top side of the respective surface structure from which it is extending. In other words, the surface structures, in particular the ledges, do not have sharp edges or otherwise abrupt directional changes such that the manufacture of the surface structures and thus the cutting insert is simplified. Further, an undercut on the ledge is thus ruled out, thereby simplifying manufacturing, e.g., by a pressing step of a sintered part.

According to one aspect, the cutting edges merge into one another in rounded corners so that effectively four rounded corners on the top side and four rounded corners on the underside are defined with which the cutting operation can be performed. The cutting edges together define a base plane, whereby the top side of the surface structures are inclined at an angle of between 5 and 20° relative to the base plane in which the cutting edges lie. The cutting edges are substantially linear in this respect.

For example, the cutting insert may be an insert, whereby both the top side and underside have a chip face. Accordingly, there are several options for inserting the cutting insert into a cutting tool so that the use of the cutting insert can be prolonged as both sides of the cutting insert can be used.

According to one aspect, the top side of the cutting insert comprises a chip-breaking trough starting from the cutting edge, wherein the surface structures are only present on the side of the trough close to the cutting edge.

When viewing the cutting insert in plan view, the ledge may have a convex extension at its end near the cutting edge. The convex extension extends to a ledge adjacent the first surface structure and located at the opposite end of the first surface structure to the second surface structure. Accordingly, the surface structure is defined by a plurality of individual structures that form a type of scale or brick.

Preferably, the surface structures have a triangular shape with a base facing the trough bottom and a tip facing towards the cutting edge. Thus, the individual surface structures are formed by triangular shapes with a corner of the triangle facing the cutting edge.

In one aspect, the cutting edge-facing ends, appearing convex in plan view, of the surface structures are spaced apart. The distance between the convex ends in plan view increases starting from the corner. In particular, the distance between the convex ends in plan view is between 0.08 mm and 0.5 mm. Thus, larger distances are designated between the convex ends of the surface structures when larger chips are cut, as the corner of the cutting insert is used for cutting.

In another aspect, the surface of the top side of the surface structures becomes increasingly smaller from the surface structures closer to the corners, such that the surface of the top side of the surface structures increases with increasing distance from the corners. This ensures that more influence is exerted on the chips in the area of the corners because more ledges act on the chip.

In one aspect, starting from the cutting edge, a strip-shaped transition portion running parallel to the cutting edge is provided, which is free from the surface structures and at which edge located away from the cutting edge the surface structures begin. The width of the strip-shaped transition portion is preferably smaller than the width of the surface structures, whereby the width of the transition strip is at least 0.1 mm. Due to the distance between the cutting edge and the surface structures given by the transition portion, the cutting edge is designed homogeneously and the stability of the cutting insert is increased.

In side view, the surface structures extend like overlying bricks on a level substructure. The transition portion forms a level part of the chip face and thus a reference plane corresponding to the aforementioned substructure. The top sides of the surface structures run at an angle of 1°-8° to this plane so that the top sides of the ledges are increasingly spaced apart from the plane.

Preferably, the top sides of each surface structure are level. However, alternatively, the surface structures may each have a curved back, i.e., a curved surface, wherein the maximum height of curvature is between 0.02 and 0.2 mm.

According to a preferred aspect, the top side is free of undercuts. That is to say, the surface is made perpendicular to a plane in which the cutting edge lies, when viewed without a lateral undercut, so that all surfaces, except those perpendicular to the plane, are visible from above.

Additionally, the cutting insert may contain friction-reducing particles that have lubricating properties or may become softer with heat from the cutting chips to form a lubrication layer. These particles also reduce friction between the cutting insert and the workpiece to be cut so that the cutting insert can be used for a long time. For example, the friction-reducing particles may be carbon (C), sulfur(S), or oil deposits in cavities provided for this purpose.

In one aspect, the ledge has a height of 0.02 mm to 0.2 mm. This ensures smooth guidance of the chips away from the corner.

According to the present invention, the object is also solved by a cutting tool comprising a holder and a cutting insert described above. The cutting insert is attached to one end of the holder. By allowing the cutting insert of the cutting tool to be interchangeable, costs can be saved, especially as the cutting insert has an increased service life due to its surface structures.

The object is also solved according to the present invention by a method for producing a cutting insert according to the present invention. The method comprises the following steps:
producing a sintered preform,
compressing the sintered preform by at least two tool parts, whereby the at least two tool parts are shaped complementary to the top side and the underside, and
heating and sintering the sintered preform.

The sintered preform can in particular be compressed in one direction by two tool parts.

Further features and advantages of the invention will be apparent from the following description as well as the attached drawings.

### DESCRIPTION OF THE DRAWINGS

The drawings show:

FIG. 1 illustrates a side view of a cutting tool according to the invention;

FIG. 2 illustrates a perspective view of a cutting insert according to the invention as used in FIG. 1;

FIG. 3 illustrates an enlarged plan view of the cutting insert according to FIG. 2 in the area of the cutting edge;

FIG. 4 illustrates a detail view of a somewhat different surface structure of a cutting insert configured as in FIG. 2 except for the surface structure;

FIG. 5 illustrates a sectional view of the cutting insert shown in FIG. 2; and

FIG. 6 illustrates a flow chart of a method according to the invention for producing the cutting insert shown in FIG. 2.

### DETAILED DESCRIPTION

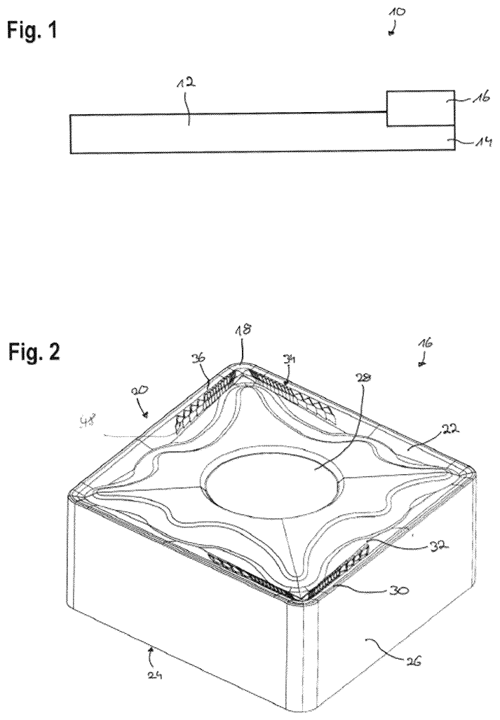

In FIG. 1, a cutting tool 10 can be seen.

The cutting tool 10 comprises a holder 12, to which end 14 a prismatic cutting insert 16 is detachably fastened.

The cutting tool 10 shown is, in particular, a cutting tool 10 for machining manufacturing methods. However, the cutting tool 10 may also be understood as a cutting tool 10 for splitting manufacturing methods.

The cutting insert 16 of the cutting tool 10 is shown in detail in FIGS. 2 to 5 and will be described below.

The cutting insert 16 is in particular a rotatable cutting plate having cutting edges. These cutting edges run substantially linearly along the associated longitudinal side of the cuboid cutting insert 16 and merge into each other in the rounded corners 18 of the cutting insert 16. While the embodiment shown in the figures indicates that only a cutting surface 22 is provided on a top side 20, the cutting insert 16 may also be an insert having a chip face 22 provided on both the top side 20 and the underside 24. Accordingly, the cutting insert 16 may be used longer, i.e., for more cutting operations, and more flexibly.

As can be seen in FIG. 2 in particular, the cutting insert 16 comprises an underside 24, an oppositely directed top side 20, and a free surface 26 between them. A hole 28 is provided in the center of the cutting insert 16, which is used to fasten the cutting insert 16 to the cutting tool 10.

The top side 20 has a chip face 22 that abuts the circumferential free surface 26. A cutting edge 30 is defined at the transition between the cutting surface 22 and the free surface 26.

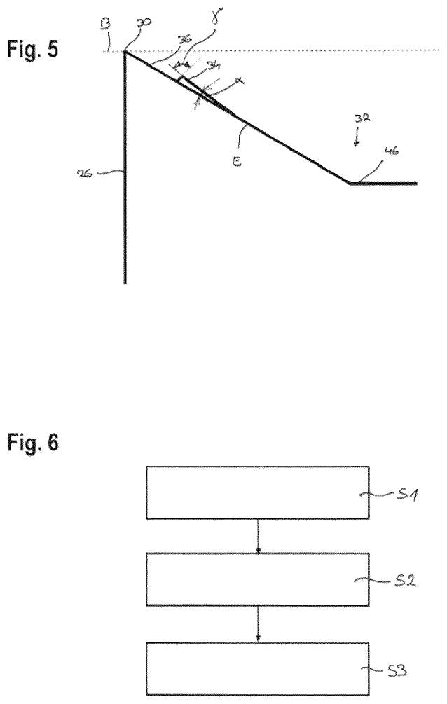

As can be seen in FIGS. 2 and 5 in particular, the cutting surface 22 runs obliquely from the cutting edge 30 towards the lower surface 24, such that a trough-like recess is created on the upper surface 20 by the cutting surface 22, forming a chip-breaking trough 32. On the distant side of the chip-breaking trough 32 from the cutting edge 30, chip-breaking contours are provided, which are designed to prevent long chips from forming.

On the side of the cutting edge 30 near the chip-breaking trough 32, however, plate-like surface structures 34 are provided. The plurality of surface structures 34 disposed on the chip face 22 are arranged in a row longitudinally to the cutting edge 30 resulting in a scale-like overall structure.

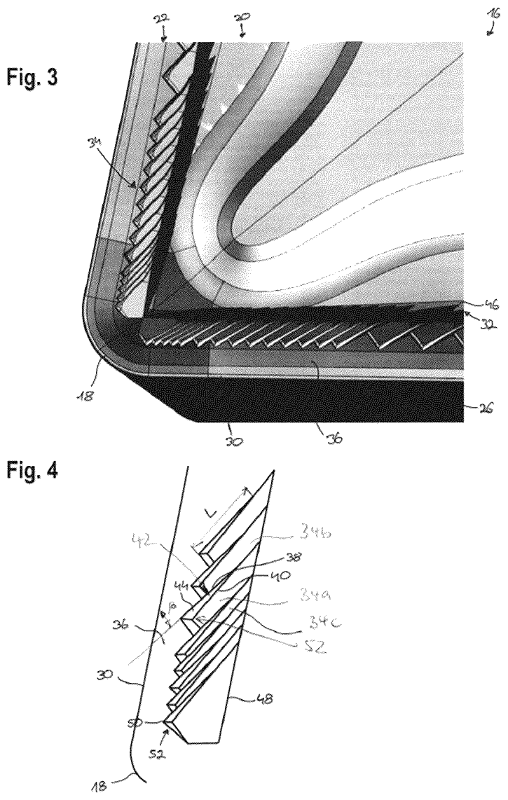

As can be seen in particular in FIG. 3, the cutting edge 30 is separated from the surface structures 34 by a strip-shaped transition portion 36 extending parallel to the cutting edge 30. Thus, the transition portion 36 subsequent to the cutting edge 30 is free of the surface structures 34, and only at the edge located away from the cutting edge 30 do the surface structures 34 begin on the chip face 22.

The width of the transition section 36 is smaller than the width of the first row of surface structures 34, but at least 0.1 mm downstream of the protective chamfer, which is adjacent the cutting edge 30.

Each of the surface structures 34 is bounded by a lower edge 38 that is transverse to the cutting edge 30 and an upper edge 40 that is transverse to the cutting edge 30. A chip-guiding ledge 42 results between the lower edge 38 of a second surface structure 34b and the adjacent upper edge 40 of the adjacent first surface structure 34a.

The ledge 42 has an end face 44, which has an inclination obliquely towards the underside 24 of the cutting insert 16 compared to the top side of the surface structure 34.

Preferably, the slope γ is greater than 90° and a maximum of 120° towards the top side of the surface structures 34, i.e., the ledge 42 does not form an undercut towards the top side of the surface structures 34.

The surface structures 34 follow the general path of the chip face 22, which is inclined towards the underside 24 starting from the cutting edge 30, as already stated above. In so doing, the chip face 22 is preferably inclined at an angle of between 5 and 25°. In addition, the surface structures 34 are also inclined downwards towards a first corner 18 of the cutting insert 16. Accordingly, the surface structures 34 also have an inclination angle of between 5° and 25°. This inclination angle relates to a base plane B (see FIG. 5) defined by cutting edges 30 transitioning into rounded corners 18. The cutting edges 30 are substantially linear, but can also have non-linear sections in plan view, as shown by the corners 18 of the cutting edges 30.

The base plane B is consequently a plane that figuratively has been placed on top of the cutting insert 16 and thus merges the substantially rectangular but rounded corners 18 into each other.

The transition portion 36 forms a level part of the chip face 22 and defines a plane E (see FIG. 5) against which the top side of the surface structures 34 occupy an angle α of 1° to 18° so that the distance of the surface to the ledges 42 increases continuously from plane E.

Plane E extends at an angle of 5° to 20° to the aforementioned base plane B (see FIG. 5). Alternatively and not shown in the figures, plane E may also be identical to the base plane B or have a negative angle of up to 25°, for example for heavy machining.

The height of the ledge 42 is in particular between 0.02 and 0.2 mm starting from plane E.

In the figures, it can be seen that the surface structures 34 have a top view of the top side 20 of the cutting insert 16 and a convex extension 52 of the ledge 42. This convex extension 52 extends to a ledge 42 adjacent the first surface structure 34a and lying at the opposite end of the first surface structure 34a to the second surface structure 34b (see FIG. 4), here at a third surface structure 34c.

The surface structures 34 thus have a triangular shape (see FIG. 2) in particular, with a base 48 facing the trough bottom 46 and a tip 50 facing towards the cutting edge 30.

In FIGS. 3 and 4, the surface structures 34 are rectangular with different side lengths, with a base 48 proximate and parallel to the trough bottom 46. The bases 48 of all surface structures 34 are e.g., on a common straight line.

Alternatively, and not shown in the figures, the surface structures 34 may also have a curved shape, i.e., the surface structures 34 do not have a tip 50 but merely a convex end at the upper edge 40.

Due to the convex ends or tips 50 of the surface structures 34 defined by the convex extension 52 of the corresponding ledge 42, the ledge 42 in plan view of the top side 20 forms an acute angle β (see FIG. 4) with the adjacent cutting edge 30.

In addition, it is noted that the ledges 42 running along the cutting edge 30 all run in the same direction (see FIG. 4). In the embodiment shown in the figures, the ledges 42 not only extend in the same direction, but additionally also parallel to each other. Alternatively, and not shown in the figures, however, the ledges 42 may also only extend in the same direction and not be parallel to each other.

In FIG. 4, in particular, the dimensions of the surface structures 34 can be seen. As noted above, each surface structure 34 has a chip-guiding ledge 42 that has a length L that ranges from 0.06 to 0.2 mm.

Generally, the surface structure 34 has a surface of the surface structure 34 measuring 0.02 to 2 mm² in plan view. Thus, the surface structures 34 are macrostructures.

However, depending on the exact dimensions of the surface structures 34, they may also be microstructures of <0.1 mm².

Referring to FIGS. 3 and 4, it can be seen that the surface of the top side of the surface structures 34 becomes increasingly smaller from the surface structures 34 closer to the corners 18. Accordingly, the surface of the top side of the surface structures 34 increases with increasing distance from the corners 18. These structures run from two cutting edges 30 towards the same corner 18.

An exception to this is the surface structure 34 closest to corner 18. Otherwise, the surface structure 34, which is farthest from the corner 18, is the largest surface. In particular, the size of the surface of the surface structures 34 from the closest location to the corner 18 increases by a factor of between 2 and 4.

The ledge 42 defining each surface structure 34 preferably extends towards the convex extension 52 such that the surface structures 34 form a type of serrated or wave pattern.

The distance between the convex ends in plan view increases starting from corner 18. The distance is in particular between 0.08 and 0.5 mm.

Despite the increasing distance between the tips 50 of the surface structures 34, the ledges 42 run at the same angle relative to the cutting edge 30, and preferably equally parallel to each other.

In the embodiments of the cutting insert 16 shown in the figures, the top sides of the surface structures 34 are level and are also non-cross-sectional in the area of the ledges 42. Alternatively, however, the surface structures 34 may each have an upwardly curved top side such that the top side of the surface structures 34 has a curvature with a height between 0.02 mm and 0.2 mm.

Also not seen in the figures, the cutting insert 16 may contain friction-reducing particles that have lubricating properties or become softer through heating from the cutting chips and form a lubrication layer. These friction-reducing particles further enhance the friction-reducing effect of the surface structures 34 so that the life of the cutting insert 16 can be extended. For example, the friction-reducing particles may be carbon (C), sulfur (S), or oil deposits in cavities.

In FIG. 6, a possible method for producing the cutting insert 16 is shown. In a first step S1, a sintered preform is provided or produced.

The sintered preform is positioned between two tool parts so that it can be compressed by the two tool parts. The tool parts are shaped complementary to the underside 24 and the top side 20. This represents step S2. Because the top side 20 and the underside 24 do not have undercuts, the surface of the surface structures 34 can only be produced by a press motion in the axial direction of the hole 28.

In the final step S3, the sintered preform is heated and sintered so that the cutting insert 16 can then be removed from the two tool parts and installed in a cutting tool 10.

In this manufacturing method, the need for machining of the surface structures 34 is no longer necessary and the cutting insert 16 may be installed directly after the manufacturing process. Alternatively, the cutting insert 16 may also be manufactured by laser contouring or rapid prototyping or by milling. Either the sintered preform or the sintered cutting insert 16 is machined.

1. A prismatic cutting insert for a cutting tool having an underside, an oppositely directed top side, which has a chip face, a free surface adjacent to the chip face, and a cutting edge defined at the transition between the chip face and the free surface, wherein the chip face is away from the cutting edge and extends obliquely towards the underside, wherein the chip face comprises a plurality of plate-like surface structures, arranged adjacent one another in a row longitudinally to and spaced apart from the cutting edge to form a scale-like overall structure, wherein the individual surface structures run diagonally downward from the cutting edge towards the underside on the one hand and on the other hand downward towards a first corner of the cutting insert, such that the surface structures are bound by a lower edge transverse to the cutting edge and an upper edge transverse to the cutting edge, and a chip-guiding ledge results between the lower edge of a second surface structure and the adjacent upper edge of the adjacent first surface structure.

2. The prismatic cutting insert according to claim 1, characterized in that the ledge in plan view of the top side forms an acute angle β with the adjacent cutting edge.

3. The prismatic cutting insert according to claim 1, characterized in that the ledges running along a cutting edge all run in the same direction and/or parallel to each other.

4. The prismatic cutting insert according to claim 1, characterized in that the surface structures are macrostructures having a surface measured from 0.02 to 2 mm² in plan view.

5. The prismatic cutting insert according to claim 1, characterized in that each ledge has a length that ranges from 0.06 to 0.2 mm.

6. The prismatic cutting insert according to claim 1, characterized in that the ledges have an end face having a slope angle γ greater than 90° and a maximum of 120° towards the top side of the respective surface structure from which they extend.

7. The prismatic cutting insert according to claim 1, characterized in that the cutting edges merge into rounded corners and together define a base plane and the top side of the surface structures is inclined at an angle of between 5° and 20° relative to the base plane in which the cutting edge lies.

8. The prismatic cutting insert according to claim 1, characterized in that the top side comprises a chip-breaking trough starting from the cutting edge and the surface structures are only present on the side of the trough close to the cutting edge.

9. The prismatic cutting insert according to claim 8, characterized in that the ledge has a convex extension when viewing the cutting insert in plan view at its end near the cutting edge extending to a ledge adjacent to the first surface structure and lying at the end of the first surface structure opposite to the second surface structure.

10. The prismatic cutting insert according to claim 9, characterized in that the surface structures have a triangular shape with a base facing a trough bottom and a tip facing toward the cutting edge.

11. The prismatic cutting insert according to claim 8, characterized in that the ends in plan view of the surface structures facing the cutting edge are convex ends and are spaced apart from each other, with the distance between the convex ends in plan view increasing from the corner, in particular wherein the distance of the convex ends in plan view is between 0.08 mm and 0.5 mm.

12. The prismatic cutting insert according to claim 1, characterized in that the surface of the top side of the surface structures becomes increasingly smaller from the surface structures closer to the corners of the cutting insert, such that the surface of the top side of the surface structures increases with increasing distance from the corners.

13. The prismatic cutting insert according to claim 1, characterized in that a strip-shaped transition portion extending parallel to the cutting edge is provided starting from the cutting edge, which is free from the surface structures and at which edge located away from the cutting edge the surface structures begin.

14. The prismatic cutting insert according to claim 13, characterized in that the transition portion defines a level part of the chip face and between the plane defined by the transition portion and the top side of the surface structures there is an angle α of 1°-8° such that the top side of the surface structures are increasingly spaced from the plane to the ledges.

15. The prismatic cutting insert according to claim 1, characterized in that the top side of each surface structure is level or curved upward.

16. The prismatic cutting insert according to claim 1, characterized in that the chip face, including its surface structures, is formed without undercutting.

17. The prismatic cutting insert according to claim 1, characterized in that the cutting insert contains friction-reducing particles that have lubricating properties or become softer through heating by the cutting chips and form a lubrication layer.

18. The prismatic cutting insert according to claim 1, characterized in that the ledge has a height of 0.02 mm to 0.2 mm.

19. A cutting tool comprising a holder and a prismatic cutting insert according to claim 1, wherein the cutting insert is fixed to an end of the holder.

20. A method for producing a prismatic cutting insert according to claim 1, comprising the steps of:
producing a sintered preform;
compressing the sintered preform by at least two tool parts, wherein the at least two tool parts are shaped complementary to the top side and the underside; and
heating and sintering the sintered preform.
